(19) United States
(12) Patent Application Publication
(10) Pub. No.: US 2026/0288825 A1
(43) Pub. Date: Sep. 24, 2026

(54) AGENDA GUIDED CONVERSATIONAL ARTIFICIAL INTELLIGENCE SYSTEMS WITH FACTUAL EVALUATION

(71) Applicant: Oracle International Corporation, Redwood Shores, CA (US)

(72) Inventors: Fahimeh Sadat Saleh, Melbourne (AU); Vladislav Blinov, Melbourne (AU); Yakuptiyage Don Thanuja Samodhye Dharmasiri, Melbourne (AU); Ying Xu, Melbourne (AU); Bhagya Gayathri Hettige, Melbourne (AU); John Stephen Calvo Martinez, Sydney (AU); Xuelin Situ, Melbourne (AU)

(73) Assignee: Oracle International Corporation, Redwood Shores, CA (US)

(21) Appl. No.: 19/576,687

(22) Filed: Mar. 24, 2026

Related U.S. Application Data
(60) Provisional application No. 63/776,638, filed on Mar. 24, 2025.

(51) Int. Cl. G06F 16/3329; G06F 11/34; G10L 15/26

(52) U.S. Cl. CPC G06F 16/33295; G06F 11/3409; G10L 15/26

(57) ABSTRACT

A computer-implemented method for evaluating agenda-driven conversational agents is disclosed. The method includes receiving a natural language utterance associated with a predefined agenda and determining, by an agent generative model, whether clarification is required. If clarification is needed, a simulated conversation is executed between the agent generative model and a mimic generative model, where each turn involves generating, by the agent generative model, one or more clarifying questions and generating, by the mimic generative model, one or more clarifying responses based on the agenda. The agent generative model generates a response to the natural language utterance based on the conversation. The agent generative model's performance in generating clarifying questions and responses is evaluated, enabling objective assessment of the agent's ability to handle complex, multi-turn interactions using agenda-driven simulated dialogue.

### CROSS-REFERENCE TO RELATED APPLICATION

The present application is a non-provisional application of and claims the benefit and priority under 35 U.S.C. 119(e) of U.S. Provisional Application No. 63/776,638, filed on Mar. 24, 2025, the entire contents of which is incorporated herein by reference in its entirety for all purposes.

### FIELD

The present disclosure relates generally to evaluating conversational artificial intelligence systems, and more particularly, to the end-to-end assessment of conversational agents using agenda-driven simulated interactions between generative models and structured evaluation metrics.

### BACKGROUND

Advancements in artificial intelligence have led to the widespread adoption of conversational agents, including chatbots, virtual assistants, and automated customer service systems, across diverse industries such as healthcare, legal, education, and consumer support. These agents are increasingly relied upon to interpret natural language queries, provide information, make decisions, and perform tasks autonomously. As their deployment grows, so too does the importance of ensuring that these agents consistently deliver accurate, reliable, and contextually appropriate responses.

However, evaluating the real-world performance of conversational agents presents significant challenges. Conventional assessment methods typically rely on static scripts, rule-based workflows, or manually engineered test cases. These approaches often fail to capture the dynamic, nuanced nature of human interaction, resulting in evaluations that may overlook critical aspects of agent behavior, such as handling ambiguous queries, responding to unexpected user inputs, or maintaining coherent dialogue across multiple conversational turns. Furthermore, scripted testing frameworks tend to penalize agents for minor deviations or alternative action sequences, even when the underlying goal is achieved, limiting the breadth and fairness of the evaluation.

Another limitation of traditional evaluation techniques is their inability to systematically detect and address the phenomenon of “hallucination”, the generation of irrelevant, incorrect, or fabricated information by large language models and AI agents. Existing solutions often lack granular mechanisms for identifying these hallucinated facts, especially when they are interspersed within complex, multi-turn conversations. As a result, agents may pass superficial accuracy checks while still producing output that is misleading or ungrounded.

The scalability of agent evaluation is also a persistent concern. Manual testing and human-in-the-loop assessments are resource-intensive, costly, and difficult to replicate on a large scale. As conversational agents become more sophisticated and are deployed in increasingly critical applications, there is a growing need for automated, robust, and objective evaluation systems that can simulate realistic user interactions and provide actionable feedback on agent performance.

Additionally, the diversity of agent architectures, tool integrations, and operational contexts complicates the process of designing evaluation scenarios that are both comprehensive and representative. Existing methods often struggle to adapt to new domains, evolving user expectations, and the wide variety of tools or APIs that agents may use to fulfill tasks. Accordingly, there remains a need for improved solutions that provide transparent and scalable evaluation of conversational agents.

### BRIEF SUMMARY

Generative AI techniques are disclosed herein (e.g., a computer implemented method, a system, non-transitory computer-readable medium storing code, or instructions executable by one or more processors) for end-to-end assessment of conversational agents using agenda-driven simulated interactions between generative models and structured evaluation metrics.

In various embodiments, the present disclosure provides a computer-implemented method comprising: receiving a natural language utterance associated with a predefined agenda; determining, by an agent generative model, to clarify the natural language utterance through one or more tasks for responding to the natural language utterance; where in response to determining to clarify the natural language utterance, executing a simulated conversation between the agent generative model and a mimic generative model in order to perform the one or more tasks and obtain a clarification of the natural language utterance, where the simulated conversation comprises one or more turns and each turn comprising: generating, by a generative model, one or more clarifying questions associates with the one or more tasks and generating, by the mimic generative model, one or more clarifying responses to the one or more clarifying questions based on the predefined agenda; generating, by the agent generative model, a response to the natural language utterance based on the natural language utterance and the simulated conversation; and evaluating performance of the agent generative model to generate the one or more clarifying questions and/or the response.

In some embodiments, the agenda is generated by a generative model or is generated automatically based on a schema describing available software tools and parameters for the agent generative model.

In some embodiments, the response comprises the one or more clarifying questions or the final response in the simulated conversation.

In some embodiments, each turn further comprises performing one or more intermediate actions for gathering of information for performing the one or more tasks, and wherein the one or more clarifying questions are responses generated by the agent generative model during the simulated conversation, the response is a final response generated by the agent generative model, and a conversational transcript comprising the responses, the final response, or both are used for evaluating the performance.

In some embodiments, a conversational transcript is generated based on the natural language utterance, the simulated conversation, and the response, wherein the performance of the agent generative model is evaluated based on the conversational transcript; and retraining, fine-tuning, or deploying the agent generative model based on the evaluating.

In some embodiments, the one or more tasks comprise disambiguation, slot filling, confirmation, or any combination thereof.

In some embodiments, executing the simulated conversation comprises providing a prompt comprising the predefined agenda to the mimic generative model, and wherein the predefined agenda includes information about the simulated conversation and a goal that needs to be achieved during the simulated conversation.

In some embodiments, the computer-implemented method further comprises: generating a conversational transcript based on the natural language utterance, the simulated conversation, and the response, wherein the performance of the agent generative model is evaluated based on the conversational transcript, and the evaluating comprises: decomposing, by an evaluation generative model, the one or more clarifying questions and/or the response in the conversational transcript into a plurality of atomic facts; comparing the plurality of atomic facts against a predefined fact list that includes a set of required facts and a set of optional facts; assigning a score to the one or more clarifying questions and/or the response based on: (i) an accuracy of required facts in the one or more clarifying questions and/or the response as determined by the comparing, (ii) an accuracy of optional facts in the one or more clarifying questions and/or the response as determined by the comparing, and (iii) an absence of extra facts outside of the reference fact list in the one or more clarifying questions and/or the response as determined by the comparing, wherein the score is indicative of accuracy and completeness of the one or more clarifying questions and/or the response and is a metric for evaluating the performance of the agent generative model; recording a sequence of actions (a sequence can be one or more actions) taken by the agent generative model during the simulated conversation, wherein each action comprises a call to a software tool including one or more parameters and comparing the sequence of actions to a predefined expected sequence of actions; and generating a performance report, based on the score and the sequence of actions, in a machine-readable format.

In some embodiments, the agent generative model and the mimic generative model are the same model or different models.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure will be better understood in view of the following non-limiting figures, in which:

FIG. 1 depicts a simplified diagram for a distributed environment incorporating an agent system, according to various embodiments.

FIG. 2 is an exemplary architecture for a generative model-based digital assistant, according to various embodiments.

FIG. 3 depicts a system architecture for the evaluation of conversational artificial intelligence systems, according to various embodiments.

FIG. 4 depicts a process flow for the evaluation of conversational artificial intelligence systems, according to various embodiments.

FIG. 5 is a block diagram illustrating one pattern for implementing a cloud infrastructure as a service system, according to various embodiments.

FIG. 6 is a block diagram illustrating another pattern for implementing a cloud infrastructure as a service system, according to various embodiments.

FIG. 7 is a block diagram illustrating another pattern for implementing a cloud infrastructure as a service system, according to various embodiments.

FIG. 8 is a block diagram illustrating another pattern for implementing a cloud infrastructure as a service system, according to various embodiments.

FIG. 9 is a block diagram illustrating an example computer system, according to various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

The proliferation of conversational artificial intelligence (AI) systems, including chatbots, virtual assistants, and automated customer service agents, has exposed persistent technical shortcomings in conventional methods used to evaluate their real-world performance. Existing evaluation approaches typically rely on static scripts, rigid state machines, or manual test cases, which are fundamentally limited in their ability to simulate the dynamic and unpredictable nature of human dialogue. Such methods fail to account for ambiguous queries, incomplete user input, evolving conversational goals, and the breadth of user behavior encountered in practice. As a result, assessments frequently overlook critical aspects of agent behavior, such as the ability to clarify ambiguous information, adapt to unexpected requests, or maintain coherent multi-turn interactions.

Conventional scoring techniques further lack granularity, often evaluating responses holistically without decomposing them into atomic factual assertions, thereby missing subtle errors, omissions, or hallucinated (fabricated) information, especially problematic in complex conversations where factual correctness is paramount. Agents may appear to perform well under scripted tests yet still generate misleading or ungrounded output. Moreover, existing frameworks impose rigid penalties for deviations from predetermined workflows, even when agents achieve underlying goals through alternative valid action sequences, reducing the fairness and adaptability of evaluation. Manual testing and human-in-the-loop assessments are resource-intensive, costly, and inconsistent, constraining the ability to scale evaluations across diverse domains, tool integrations, and operational contexts. Conventional methods also fail to provide granular insight into whether agents correctly sequence tool or API calls, supply appropriate parameters, or adapt to varying operational requirements and multiplicity of conversational paths and dependencies between conversation steps, allowing errors in internal decision-making to escape detection despite their real-world impact.

In order to address these challenges and others, the present disclosure provides an automated, agenda-driven evaluation system for conversational agents. Central to this technical solution is the implementation of a simulated conversation between a first agent (also described herein as an agent generative model under evaluation) and second agent (also described herein as a mimic generative model simulating a user). The simulated conversation is initiated by the first agent to gather information for responding to a given natural language utterance. The natural language utterance is the input provided to the first agent for evaluation, and it represents the kind of user query or request the first agent would encounter in real-world operation. This utterance can take various forms: it may be a manually crafted test question, a dynamically generated query (for example, using templates or language models), or a scenario-specific prompt designed to test particular agent capabilities. The utterance serves as the starting point for the evaluation process, triggering the simulated conversation between the agent and a mimic generative model.

Once initiated, the simulated conversation between the two agents is guided by the concept of an agenda. The agenda is a structured specification of the evaluation scenario. The agenda defines the intended goal, required parameters, constraints, and context for the conversation. The agenda may include information such as the user's intent, relevant dates, locations, or any particular requirements for the task the agent is supposed to fulfill. The agenda is generated either by a generative model, automatically from a schema describing available tools, or programmatically based on test requirements. The association between the natural language utterance and the agenda is important because it ensures that the simulated conversation is coherent, contextually relevant, and aligned with realistic user goals. The utterance is linked to the agenda at varying levels of abstraction. For example, sometimes, the utterance is explicitly included as a test query in the agenda (e.g., “Book a restaurant for dinner in Atlanta at 7 pm”). Other times, the agenda maps to one or more possible utterances via scenario identifiers, metadata, or configuration files. The utterance may also be generated dynamically based on the agenda's slot-filling requirements (e.g., constructing a query using the parameters specified in the agenda). For example, given an agenda specifying a restaurant reservation with parameters such as city (“Atlanta”), number of guests (4), date (“2026 Mar. 10”), and time (“19:00”), the system can construct a natural language utterance by filling these values into a template, resulting in a query such as “Book a restaurant in Atlanta for four people at 7 pm on Mar. 10, 2026.” This dynamic utterance generation ensures that all required scenario parameters are included and allows for a wide variety of realistic test queries to be programmatically created from structured agenda data. In some cases, the association is implicit, for example, the utterance simply reflects the goals and constraints outlined in the agenda, even if not directly referenced. This granularity enables flexible, scalable, and comprehensive evaluation scenarios across one-to-one, one-to-many, many-to-one, or many to many mappings.

The agenda can also be generated automatically based on a schema describing available software tools and their parameters. The schema may be defined, for example, as a JSON or YAML object that lists the tools accessible to the agent generative model, the parameters required by each tool, their data types, value constraints, and the outputs they produce. For illustration, consider a schema for a restaurant reservation API:

```
‘json
{
    ″tool_name″: ″BookRestaurant″,
    ″parameters″: [
    {″name″: ″city″, ″type″: ″string″, ″required″: true},
    {″name″: ″date″, ″type″: ″date″, ″required″: true},
    {″name″: ″time″, ″type″: ″time″, ″required″: true},
    {″name″: ″party_size″, ″type″: ″integer″, ″required″: true},
    {″name″: ″special_requests″, ″type″: ″string″, ″required″: false}
  ],
″outputs″: [
    {″name″: ″reservation_status″, ″type″: ″string″},
    {″name″: ″confirmation_code″, ″type″: ″string″}
  ]
}
‘
```

The system selects values for each required parameter (e.g., city=“Atlanta”, date=“2026 Mar. 10”, time=“19:00”, party_size=4) and optional parameters as needed. The agenda is then assembled by populating a template with these values, resulting in a structured scenario such as:
Goal: Book a restaurant reservation.
Parameters: city=Atlanta, date=2026 Mar. 10, time=19:00, party_size=4
Special requests: none
   The schema ensures that all required parameters for the tool are present in the agenda.

The system orchestrates realistic, agenda-driven interactions between the first agent and the second agent, where the agents attempt to fulfill the scenario defined by the agenda through multi-turn exchanges, requesting clarifications, confirming details, and executing actions as needed. Agent responses are decomposed into atomic facts (the smallest units of factual information) and compared against a reference fact list composed of required and optional facts. The system systematically penalizes hallucinated or extra facts (those not present in the reference list) and flags missing or incorrectly stated required and optional facts, enabling fine-grained, objective assessment of factual accuracy throughout the conversation. The sequence of internal actions taken by the first agent, including tool/API calls and parameter selections, is logged and compared against expected workflows, allowing both conventional and creative agent strategies to be fairly assessed and providing insight into the first agent's reasoning and operational effectiveness. All conversation turns, factual comparisons, and workflow actions are recorded in structured, machine-readable transcripts and performance reports, facilitating automated feedback loops for retraining, fine-tuning, and deployment, and supporting large-scale, repeatable evaluations across varied operational contexts.

The architecture of the system is adaptable and extensible, accommodating diverse agent designs, tool integrations, languages, and modalities, and supporting batch testing, multi-lingual and multi-modal scenarios, and dynamic reference fact list generation for evolving domains. By leveraging structured agendas, generative model simulation, atomic fact decomposition, and transparent workflow analysis, the system provides a robust, scalable, and objective solution to the limitations of conventional conversational agent evaluation. It ensures that agents are rigorously assessed for their ability to handle realistic user interactions, maintain factual correctness, avoid hallucinations, and execute tasks effectively within complex, real-world scenarios.

In some aspects, this technical solution is embodied as a computer-implemented method that comprises: receiving a natural language utterance associated with a predefined agenda; determining, by an agent generative model, to clarify the natural language utterance through one or more tasks for responding to the natural language utterance; where in response to determining to clarify the natural language utterance, executing a simulated conversation between the agent generative model and a mimic generative model in order to perform the one or more tasks and obtain a clarification of the natural language utterance, where the simulated conversation comprises one or more turns and each turn comprising: generating, by a generative model, one or more clarifying questions associated with the one or more tasks and generating, by the mimic generative model, one or more clarifying responses to the one or more clarifying questions based on the predefined agenda; generating, by the agent generative model, a response to the natural language utterance based on the natural language utterance and the simulated conversation; and evaluating performance of the agent generative model to generate the one or more clarifying questions and/or the response.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc.

As used herein, when an action is “based on” something, this means the action is based at least in part on at least a part of the something.

### Digital Assistant and Knowledge Dialog

A bot (also referred to as an agent, chatbot, chatterbot, or talkbot), implemented as part of or as a digital assistant, is a computer program that can perform conversations with end users. The bot can generally respond to natural-language messages (e.g., questions or comments) through a messaging application that uses natural-language messages. Enterprises may use one or more bot systems to communicate with end users through a messaging application. The messaging application, which may be referred to as a channel, may be an end user preferred messaging application that the end user has already installed and familiar with. Thus, the end user does not need to download and install new applications in order to chat with the bot system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile, web, and cloud application extensions or plugins that extend native or hybrid/responsive mobile, web, or cloud applications with chat capabilities, or voice based input (such as devices or apps with interfaces that use Siri, Cortana, Google Voice, or other speech input for interaction).

In some examples, a bot system may be associated with a Uniform Resource Identifier (URI). The URI may identify the bot system using a string of characters. The URI may be used as a webhook for one or more messaging application systems. The URI may include, for example, a Uniform Resource Locator (URL) or a Uniform Resource Name (URN). The bot system may be designed to receive a message (e.g., a hypertext transfer protocol (HTTP) post call message) from a messaging application system. The HTTP post call message may be directed to the URI from the messaging application system. In some embodiments, the message may be different from a HTTP post call message. For example, the bot system may receive a message from a Short Message Service (SMS). While discussion herein may refer to communications that the bot system receives as a message, it should be understood that the message may be an HTTP post call message, a SMS message, or any other type of communication between two systems.

End users may interact with the bot system through a conversational interaction (sometimes referred to as a conversational user interface (UI)), just as interactions between people. In some cases, the interaction may include the end user saying “Hello” to the bot and the bot responding with a “Hi” and asking the end user how it can help. In some cases, the interaction may also be a transactional interaction with, for example, a banking bot, such as transferring money from one account to another; an informational interaction with, for example, a HR bot, such as checking for vacation balance; or an interaction with, for example, a retail bot, such as discussing returning purchased goods or seeking technical support.

In some embodiments, the bot system may intelligently handle end user interactions without interaction with an administrator or developer of the bot system. For example, an end user may send one or more messages to the bot system in order to achieve a desired goal. A message may include certain content, such as text, emojis, audio, image, video, or other method of conveying a message. In some embodiments, the bot system may convert the content into a standardized form (e.g., a representational state transfer (REST) or API call against enterprise services with the proper parameters) and generate a natural language response. The bot system may also prompt the end user for additional input parameters or request other additional information. In some embodiments, the bot system may also initiate communication with the end user, rather than passively responding to end user utterances. Described herein are various techniques for identifying an explicit invocation of a bot system and determining an input for the bot system being invoked. In certain embodiments, explicit invocation analysis is performed by a master bot based on detecting an invocation name in an utterance. In response to detection of the invocation name, the utterance may be refined or pre-processed for input to a bot that is identified to be associated with the invocation name and/or communication.

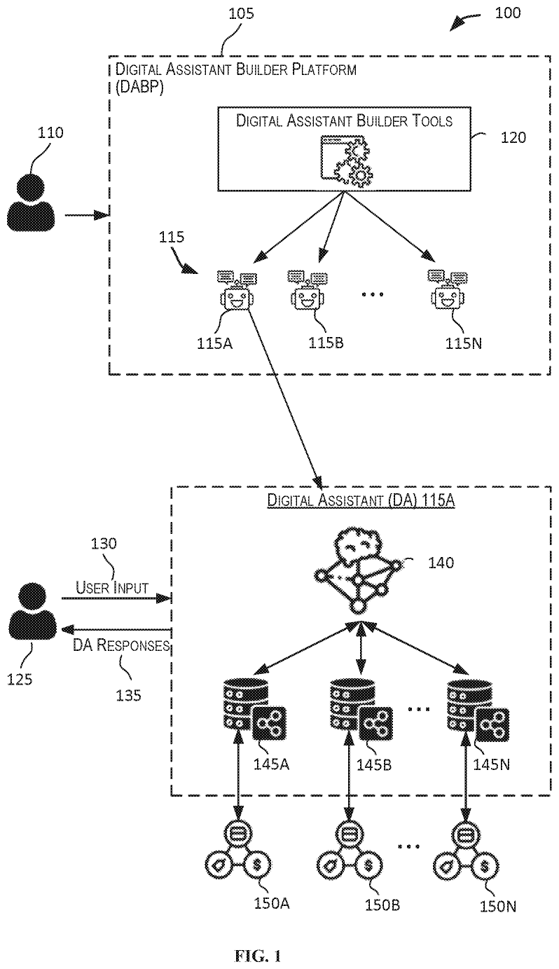

FIG. 1 is a simplified block diagram of an environment 100 incorporating a digital assistant system (also described herein as simply a digital assistant or in more specific terms with reference to implementation of agents as an agent assistant) according to certain embodiments. Environment 100 includes a digital assistant builder platform (DABP) 105 that enables users 110 to create and deploy digital assistant systems 115. For purposes of this disclosure, a digital assistant is an entity that helps users of the digital assistant accomplish various tasks through natural language conversations. The DABP and digital assistant can be implemented using software only (e.g., the digital assistant is a digital entity implemented using programs, code, or instructions executable by one or more processors), using hardware, or using a combination of hardware and software. In some instances, the environment 100 is part of an Infrastructure as a Service (IaaS) cloud service (as described below in detail) and the DABP and digital assistant can be implemented as part of the IaaS by leveraging the scalable computing resources and storage capabilities provided by the IaaS provider to process and manage large volumes of data and complex computations. This setup allows the DABP and digital assistant to deliver real-time, responsive interactions while ensuring high availability, security, and performance scalability to meet varying demand levels. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

DABP 105 can be used to create one or more digital assistant systems (or DAs). For example, as illustrated in FIG. 1, user 110 representing a particular enterprise can use DABP 105 to create and deploy a digital assistant 115A for users of the particular enterprise. For example, DABP 105 can be used by a bank to create one or more digital assistants for use by the bank's customers, for example to change a 401k contribution, etc. The same DABP 105 platform can be used by multiple enterprises to create digital assistants. As another example, an owner of a restaurant, such as a pizza shop, may use DABP 105 to create and deploy digital assistant 115B that enables customers of the restaurant to order food (e.g., order pizza).

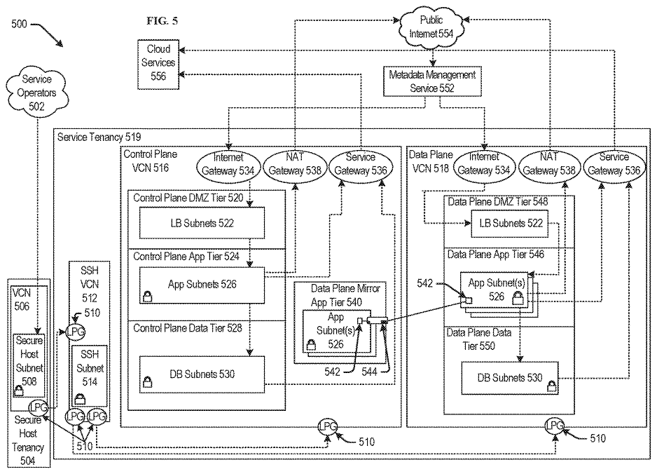

To create one or more digital assistant systems 115, the DABP 105 is equipped with a suite of tools 120, enabling the acquisition of machine learning models, agent creation, asset identification, and deployment of digital assistant systems within a service architecture for users via a computing platform such as a cloud computing platform described in detail with respect to FIGS. 5-9. In the specific context of this disclosure, the machine learning model(s) may be one or more generative models. A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text or code synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

In some instances, the tools 120 can be utilized to access pre-trained and/or fine-tuned generative models such as LLMs from data repositories or computing systems. The pre-trained LLMs serve as foundational elements, possessing extensive language understanding derived from vast datasets. This capability enables the models to generate coherent responses across various topics, facilitating transfer learning. Pre-trained models offer cost-effectiveness and flexibility, which allows for scalable improvements and continuous pre-training with new data, often establishing benchmarks in Natural Language Processing (NLP) tasks. Conversely, fine-tuned models are specifically trained for tasks or industries (e.g., plan creation utilizing the LLM's in-context learning capability, knowledge or information retrieval on behalf of an agent, response generation for human-like conversation, etc.), enhancing their performance on specific applications and enabling efficient learning from smaller, specialized datasets. Fine-tuning provides advantages such as task specialization, data efficiency, quicker training times, model customization, and resource efficiency. In some embodiments, fine-tuning may be particularly advantageous for niche applications and ongoing enhancement.

In other instances, the tools 120 can be utilized to pre-train and/or fine-tune the LLMs. The tools 120, or any subset thereof, may be standalone or part of a machine-learning operationalization framework, inclusive of hardware components like processors (e.g., CPU, GPU, TPU, FPGA, or any combination), memory, and storage. This framework operates software or computer program instructions (e.g., TensorFlow, PyTorch, Keras, etc.) to execute arithmetic, logic, input/output commands for training, validating, and deploying machine-learning models in a production environment. In certain instances, the tools 120 implement the training, validating, and deploying of the models using a cloud platform such as Oracle Cloud Infrastructure (OCI). Leveraging a cloud platform can make machine-learning more accessible, flexible, and cost-effective, which can facilitate faster model development and deployment for developers.

The tools 120 further include a prompt-based agent composition unit for creating agents and their associated actions that an end-user can end up invoking. An agent is a container of agent actions and can be part of one or more digital assistants. Each digital assistant may contain one or more agents through a digital assistant relation, which is the intersection entity that links an agent to a digital assistant. The agent and digital assistant are implemented as bot subtypes and may be persisted into an existing BOTS table. This has advantages in terms of reuse of design-time code (e.g., Java code) and UI artefacts.

An agent action is of a specific action type (e.g., knowledge, service or API, LLM, etc.) and contains a description and schema (e.g., JSON schema) which defines the action parameters. The action description and parameters schema are indexed by semantic index and sent to the planner to select the appropriate action(s) to execute. The action parameters are key-value pairs that are input for the action execution. They are derived from the properties in the schema but may also include additional UI/dialog properties that are used for slot filling dialogs. The actions can be part of one or more classes. For example, some actions may be part of an application event subscription class, which defines an agent action that should be executed when an application event is received. The application event can be received in the form of un update application context command message. An application event property mapping class (part of the application event subscription class) specifically maps the application event payload properties to corresponding agent action parameters. An action can optionally be part of an action group. An action group may be used when importing a plugin manifest, or when importing an external API spec such as an Open API spec. An action group is particularly useful when re-importing a plugin or open API spec, so new actions can be added, existing actions can be updated, or actions that are no longer present in the new manifest or Open API spec can be removed. At runtime, an action group may only be used to limit the application context groups that are sent to the LLM as conversation context by looking up the action group name which corresponds to a context group context.

The agents (e.g., 401k Change Contribution Agent) may be primarily defined as a compilation of agent artifacts using natural language within the prompt-based agent composition unit. Users 110 can create functional agents quickly by providing agent artifact information, parameters, and configurations and by pointing to assets. The assets can be or include resources, such as APIs for interfacing with applications, files and/or documents for retrieving knowledge, data stores for interacting with data, and the like, available to the agents for the execution of actions. The assets are imported, and then the users 110 can use natural language again to provide additional API customizations for dialog and routing/reasoning. Most of what an agent does may involve executing actions. An action can be an explicit action that's authored using natural language (similar to creating agent artifacts—e.g., ‘What is the impact of XYZ on my 401k Contribution limit?’ action in the below ‘401k Contribution Agent’ figure) or an implicit action that is created when an asset is imported (automatically imported upon pointing to a given asset based on metadata and/or specifications associated with the asset—e.g., actions created for Change Contribution and Get Contribution API in the below ‘401k Contribution Agent’ figure). The design time user can easily create explicit actions. For example, the user can choose the ‘Rich Text’ action type (see Table 1 for a list of exemplary action types) and creates the name artifact ‘What is the impact of XYZ on my 401k Contribution limit?’ when the user learns that a new FAQ needs to be added, as it's not currently in the knowledge documents (assets) the agent references (thus was not implicitly added as an action).

TABLE 1

| | Action Type | Description |
|---|---|---|
| 1 | Prompt | The action is implemented using a prompt to an LLM. |
| 2 | Rich Text | The action is implemented using rich text. The most |
| | | common use case is FAQs. |
| 3 | Flow | The action is implemented using Visual Flow Designer |
| | | flow. May be used for complex cases where the |
| | | developer is not able to use the out-of-the-box |
| | | dialogue and dialog customizations. |

There are various ways in which the agents and assets can be associated or added to a digital assistant 115. In some instances, the agents can be developed by an enterprise and then added to a digital assistant using DABP 105. In other instances, the agents can be developed and created using DABP 105 and then added to a digital assistant created using DABP 105. In yet other instances, DABP 105 provides an online digital store (referred to as an “agent store”) that offers various pre-created agents directed to a wide range of tasks and actions. The agents offered through the agent store may also expose various cloud services. In order to add the agents to a digital assistant being generated using DABP 105, a user 110 of DABP 105 can access assets via tools 120, select specific assets for an agent, initiate a few mock chat conversations with the agent, and indicate that the agent is to be added to the digital assistant created using DABP 105.

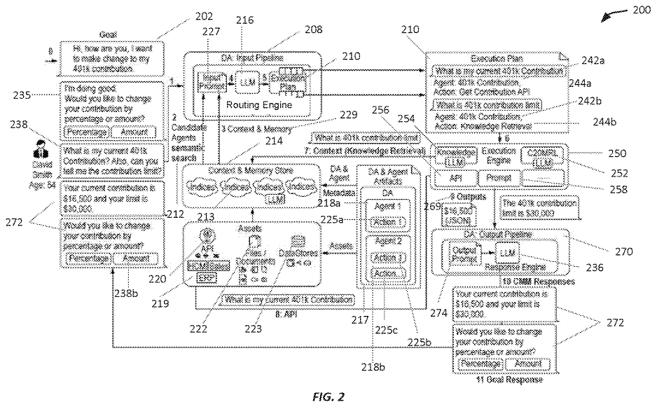

Once deployed in a production environment, such as the architecture described with respect to FIG. 2, a digital assistant, such as digital assistant 115A built using DABP 105, can be used to perform various tasks via natural language-based conversations between the digital assistant 115A and its users 125. As described above, the digital assistant 115A illustrated in FIG. 1, can be made available or accessible to its users 125 through a variety of different channels, such as but not limited to, via certain applications, via social media platforms, via various messaging services and applications, and other applications or channels. A single digital assistant can have several channels configured for it so that it can be run on and be accessed by different services simultaneously.

As part of a conversation, a user 125 may provide one or more user inputs 130 to digital assistant 115A and get responses 135 back from digital assistant 115A via a user interface element such as a chat window. A conversation can include one or more of user inputs 130 and responses 135. Via these conversations, a user 125 can request one or more tasks to be performed by the digital assistant 115A and, in response, the digital assistant 115A is configured to perform the user-requested tasks and respond with appropriate responses to the user 125 using one or more LLMs 140. Conversations shown in the chat window can be organized by thread. For example, in some applications, a conversation related to one page of an application should not be mixed with a conversation related to another page of the application. The application and/or the plugins for the application define the thread boundaries (e.g., a set of (nested) plugins can run within their own thread). Effectively, the chat window will only show the history of messages that belong to the same thread. Setting and changing the thread can be performed via the application and/or the plugins using an update application context command message. Additionally or alternatively, the thread can be changed via an execution plan orchestrator when a user query is matched to a plugin semantic action and the plugin runs in a thread different than the current thread. In this case, the planner changes threads, so that any messages sent in response to the action being executed are shown in the correct new thread. Per agent dialog thread, the following information can be maintained by the digital assistant: the application context, the LLM conversation history, the conversation history with the user, and the agent execution context which holds information about the (stacked) execution plan(s) related to this thread.

User inputs 130 are generally in a natural language form and are referred to as utterances, which may also be referred to as prompts, queries, requests, and the like. The user inputs 130 can be in text form, such as when a user types in a sentence, a question, a text fragment, or even a single word and provides it as input to digital assistant 115A. In some embodiments, a user input 130 can be in audio input or speech form, such as when a user says or speaks something that is provided as input to digital assistant 115A. The user inputs 130 are typically in a language spoken by the user 125. For example, the user inputs 130 may be in English, or some other language. When a user input 130 is in speech form, the speech input is converted to text form user input 130 in that particular language and the text utterances are then processed by digital assistant 115A. Various speech-to-text processing techniques may be used to convert a speech or audio input to a text utterance, which is then processed by digital assistant 115A. In some embodiments, the speech-to-text conversion may be done by digital assistant 115A itself. For purposes of this disclosure, it is assumed that the user inputs 130 are text utterances that have been provided directly by a user 125 of digital assistant 115A or are the results of conversion of input speech utterances to text form. This however is not intended to be limiting or restrictive in any manner.

The user inputs 130 can be used by the digital assistant 115A to determine a list of candidate agents 145A-N. The list of candidate agents (e.g., 145A-N) includes agents configured to perform one or more actions that could potentially facilitate a response 135 to the user input 130. The list may be determined by running a search, such as a semantic search, on a context and memory store that has one or more indices comprising metadata for all agents 145 available to the digital assistant 115A. Metadata for the candidate agents 145A-N in the list of candidate agents is then combined with the user input to construct an input prompt for the one or more LLMs 140.

Digital assistant 115A is configured to use one or more generative models such as LLMs 140 to apply NLP techniques to text and/or speech to understand the input prompt and apply natural language understanding (NLU) including syntactic and semantic analysis of the text and/or speech to determine the meaning of the user inputs 130. Determining the meaning of the utterance may involve identifying the goal of the user, one or more intents of the user, the context surrounding various words or phrases or sentences, one or more entities corresponding to the utterance, and the like. The NLU processing can include parsing the received user inputs 130 to understand the structure and meaning of the utterance, refining and reforming the utterance to develop a better understandable form (e.g., logical form) or structure for the utterance. The NLU processing performed can include various NLP-related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain instances, the NLU processing, or any portions thereof, is performed by the LLMs 140 themselves. In other instances, the LLMs 140 use other resources to perform portions of the NLU processing. For example, the syntax and structure of an input utterance sentence may be identified by processing the sentence using a parser, a part-of-speech tagger, a named entity recognition model, a pretrained language model such as BERT, or the like.

Upon understanding the meaning of an utterance, the one or more LLMs 140 generate an execution plan that identifies one or more agents (e.g., agent 145A) from the list of candidate agents to execute and perform one or more actions or operations responsive to the understood meaning or goal of the user. The one or more actions or operations are then executed by the digital assistant 115A on one or more assets (e.g., asset 150A-knowledge, API, SQL operations, etc.) and/or the context and memory store. The execution of the one or more actions or operations generates output data from one or more assets and/or relevant context and memory information from a context and memory store comprising context for a present conversation with the digital assistant 115A. The output data and relevant context and memory information are then combined with the user input 130 to construct an output prompt for one or more LLMs 140. The LLMs 140 synthesize the response 135 to the user input 130 based on the output data and relevant context and memory information, and the user input 130. The response 135 is then sent to the user 125 as an individual response or as part of a conversation with the user 125.

For example, a user input 130 may request a pizza to be ordered by providing an utterance such as “I want to order a pizza.” Upon receiving such an utterance, digital assistant 115A is configured to understand the meaning or goal of the utterance and take appropriate actions. The appropriate actions may involve, for example, providing responses 135 to the user with questions requesting user input on the type of pizza the user desires to order, the size of the pizza, any toppings for the pizza, and the like. The questions requesting user may be generated by executing an action via an agent (e.g., agent 145A) on a knowledge asset (e.g., a menu for a pizza restaurant) to retrieve information that is pertinent to ordering a pizza (e.g., to order a pizza a user must provide type, seize, topping, etc.). The responses 135 provided by digital assistant 115A may also be in natural language form and typically in the same language as the user input 130. As part of generating these responses 135, digital assistant 115A may perform natural language generation (NLG) using the one or more LLMs 140. For the user ordering a pizza, via the conversation between the user and digital assistant 115A, the digital assistant 115A may guide the user to provide all the requisite information for the pizza order, and then at the end of the conversation cause the pizza to be ordered. The ordering may be performed by executing an action via an agent (e.g., agent 145A) on an API asset (e.g., an API for ordering pizza) to upload or provide the pizza order to the ordering system of the restaurant. Digital assistant 115A may end the conversation by generating a final response 135 providing information to the user 125 indicating that the pizza has been ordered.

While the various examples provided in this disclosure describe and/or illustrate utterances in the English language, this is meant only as an example. In certain embodiments, digital assistants 115 are also capable of handling utterances in languages other than English. Digital assistants 115 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

While the embodiment in FIG. 1 illustrates the digital assistant 115A including one or more LLMs 140 and one or more agents 145A-N, this is not intended to be limiting. A digital assistant can include various other components (e.g., other systems, subsystems, and generative models as described in greater detail with respect to FIG. 2) that provide the functionalities of the digital assistant. The digital assistant 115A and its systems and subsystems may be implemented only in software (e.g., code, instructions stored on a computer-readable medium and executable by one or more processors), in hardware only, or in implementations that use a combination of software and hardware.

FIG. 2 is an example of an architecture for a computing environment 200 for a digital assistant implemented with generative artificial intelligence in accordance with various embodiments. As illustrated in FIG. 2, an infrastructure and various services and features can be used to enable a user to interact with a digital assistant (e.g., digital assistant 115A described with respect to FIG. 1) based at least in part on a series of prompts such as a conversation and/or a series of actions such as interactions with a user interface. The following is a detailed walkthrough of a conversation flow and the role and responsibility of the components, services, models, and the like of the computing environment 200 within a conversation flow. In this walkthrough, it is assumed that a user “David” is interested in making a change to his 401k contribution, and in an utterance 202, David provides the following input: Hi, how are you, I want to make a change to my 401k contribution. The utterance 202 can be communicated to the digital assistant (e.g., via a digital assistant user interface such as a text dialogue box or microphone). At this stage upon receipt of the utterance 202, a sessionizer creates a new session or retrieves the current session context and a user message publisher updates session transcript and LLM message history with the new user message (e.g., utterance 202).

In instances where the user provides the utterance 202 and/or performs an action while using an application supported by a digital assistant, the application issues update application context commands as the user interacts with the application (e.g., provides an utterance via text or audio, triggers a user interface element, navigates between pages of the application, and the like). Whenever an update application context command message is received by the digital assistant from the application, the application context processor (part of the context manager) is implemented. The application context processor performs the following tasks: (i) manages dialog threads based on the application context message, e.g., if the threadId specified with the message doesn't exist yet, a new dialog thread is created and made current, and if the threadId already exists, the corresponding dialog thread is made current, (ii) creates or updates the application context object for the current dialog thread, (iii) if a service call ID such as a REST request ID is included, the application context may be enriched (as described in greater detail herein). As should be understood, the application context only contains information that reflects the state of the application user interface and plugins (if available), it does not contain other state information (e.g., user or page state information/context).

Is some instances, when an update application context command message is received, an application event processor checks on whether the update application context command message includes an event definition. The event is uniquely identified by the following properties in the message payload: (i) context: the context path and/or the plugin path (For a top-level workspace plugin the context is set to the plugin name, for nested plugins the plugin path is included where plugins are separated with a slash, for example Patient/Vitalschart), (ii) eventType: the type of event can be one of the built in events or a custom event, and (iii) semantic object: the semantic object to which the event applies. An event can be mapped to one or more actions, and the message payload properties can be mapped to action parameters. This mapping takes place through an application event subscription. Each property in the message payload can be mapped to an agent action parameter using an application event property mapping.

In some instances, the utterance 202 and/or action performed by the user is provided directly as input to a routing engine 208 (also referred to as a planner). In other instances where the application event processor is implemented, the utterance 202 and/or action performed by the user is provided as input to the routing engine 208 when the application event processor determines an event such as receipt of utterance 202 is mapped to an agent or action associated with the digital assistant. The routing engine 208 is used by the digital assistant to create an execution plan 210 with specified parameters either from the utterance 202, the action performed by the user, the context, or any combination thereof. The execution plan 210 identifies one or more agents and/or one or more actions for the one or more agents to execute in response to the utterance 202 and/or action performed by the user.

A two-step approach can be taken via the routing engine 208 to generate the execution plan 210. First, a search 212 can be performed to identify a list of candidate agents and/or actions. The search 212 comprises running a query on indices 213 (e.g., semantic indices) of a context and memory store 214 based on the utterance 202 and/or action performed by the user. In some instances, the search 212 is a semantic search performed using words from the utterance 202 and/or representative of the action performed by the user. The semantic search uses NLP and optionally machine learning techniques to understand the meaning of the utterance 202 and/or action performed by the user and retrieve relevant information from the context and memory store 214. In contrast to traditional keyword-based searches, which rely on exact matches between the words in the query and the data in the context and memory store 214, a semantic search takes into account the relationships between words, the context of the query and/or action, synonyms, and other linguistic nuances. This allows the digital assistant to provide more accurate and contextually relevant results, making it more effective in understanding the user's intent in the utterance 202 and/or action performed by the user.

In order to run the query, the routing engine 208 calls the context and memory store 214 (e.g., a semantic index of the context and memory store 214) to get the list of candidate agents and/or actions. The following information is passed in the call: (i) the ID of the digital assistant (the ID scopes the set of agent and/or actions the semantic index will search for and thus the agents and/or actions must be part of the digital assistant), and (ii) the last X number of user messages and/or actions (e.g., X can be set to the last 5 turns), which can be configurable through the digital assistant settings. Upon receiving the list of candidate agents and/or actions, the routing engine 208 can identify an associated schema with the actions and perform slot-filling to determine any missing input arguments for the schema.

The context and memory store 214 is implemented using a data framework for connecting external data to one or more generative models such as LLMs 216 to make it easy for users to plug in custom data sources. The data framework provides rich and efficient retrieval mechanisms over data from various sources such as files, documents, datastores, APIs, and the like. The data can be external (e.g., enterprise assets) and/or internal (e.g., user preferences, memory, digital assistant, and agent metadata, etc.). In some instances, the data comprises metadata extracted from artifacts 217 associated with the digital assistant and its agents 218 (e.g., 218a and 218b). The artifacts 217 for the digital assistant include information on the general capabilities of the digital assistant and specific information concerning the capabilities of each of the agents 218 (e.g., actions) available to the digital assistant (e.g., agent artifacts). Additionally or alternatively, the artifacts 217 can encompass parameters or information associated with the artifacts 217 and that can be used to define the agents 218 in which the parameters or information associated with the artifacts 217 can include a name, a description, one or more actions, one or more assets, one or more customizations, etc. In some instances, the data further includes metadata extracted from assets 219 associated with the digital assistant and its agents 218 (e.g., 218a and 218b). The assets 219 may be resources, such as APIs 220, files and/or documents 222, data stores 223, and the like, available to the agents 218 for the execution of actions (e.g., actions 225a, 225b, and 225c). The data is indexed in the context and memory store 214 as indices 213, which are data structures that provide a fast and efficient way to look up and retrieve specific data records within the data. Consequently, the context and memory store 214 provides a searchable comprehensive record of the capabilities of all agents and associated assets that are available to the digital assistant for responding to the request and/or action.

The response of context and memory store 214 is converted into a list of agent and/or action instances that are not just available to the digital assistant for responding to the request but also potentially capable of facilitating the generation of a response to the utterance 202 and/or action performed by the user. The list of candidate agents and/or actions includes the metadata (e.g., metadata extracted from artifacts 217 and assets 219) from the context and memory store 214 that is associated with each of the candidate agents and/or actions. The list can be limited to a predetermined number of candidate agents and/or actions (e.g., top 10) that satisfy the query or can include all agents and/or actions that satisfy the query. The list of candidate agents and/or actions with associated metadata is appended to the utterance 202 and/or action performed by the user to construct an input prompt 227 for the LLM 216. The search 212 is important to the digital assistant because it filters out agents and/or actions that are unlikely to be capable of facilitating the generation of a response to the utterance 202 and/or action performed by the user. This filter ensures that the number of tokens (e.g., word tokens) generated from the input prompt 227 remains under a maximum token limit or context limit set for the LLM 216. Token limits represent the maximum amount of text that can be inputted into an LLM. This limit is of a technical nature and arises due to computational constraints, such as memory and processing resources, and thus makes certain that the LLMs can take the input prompt as input.

In some instances, one or more knowledge actions are additionally appended to the list of candidate agents and the utterance 202. The knowledge actions allow for additional knowledge to be acquired that is pertinent to the utterance 202 and/or action performed by the user (this knowledge is typically outside the scope of the knowledge used to train an LLM of the digital assistant). The are two types of knowledge action sources: (i) structure: the knowledge source defines a list of pre-defined questions that the user might ask and exposes them as some APIs (e.g., Multum), and (ii) unstructured: with the knowledge source, the user has unlimited ways to ask questions and the knowledge source exposes a generic query interface (e.g., medical documents (SOAP notes, discharge summary, etc.)).

In some instances, conversation context 229 concerning the utterance 202 are additionally appended to the list of candidate agents and the utterance 202. The conversation context 229 can be retrievable from one or more sources including the context and memory store 214, and includes user session information, dialog state, conversation or contextual history, application context, page context, user information, or any combination thereof. For example, the conversation context 229 can include: the current date and time, needed to resolve temporal references in user query like “yesterday”, or “next Thursday”, additional context, which contains information such as user profile properties and application context groups with semantic object properties, and the chat history with the digital assistant (and/or other digital assistant or system internal or external to the computing environment 200.

The second step of the two-step approach is for the LLM 216 to generate an execution plan 210 based on the input prompt 227. The LLM 216 can be invoked by creating an LLM chat message with role system passing in the input prompt 227, converting the candidate agents and/or actions into LLM function definitions, retrieving a proper LLM client based on the LLM configuration options, optionally transforming the input prompt 227, LLM chat message, etc. into a proper format for the LLM client, and sending the LLM chat message to the LLM client for invoking the LLM 216. The LLM client then sends back an LLM success response in CLMI format or a provider specific response is converted back to the LLM success response in CLMI format using an adapter such as OpenAIAdapter (or send back or is converted to an LLM error response in case an unexpected error occurred). An LLM call instance is created and added to the conversation history which captures all the request and response details including the execution time.

The LLM 216 has a deep generative model architecture (e.g., a reversible or autoregressive architecture with) for generating the execution plan 210. In some instances, the LLM 216 has over 100 billion parameters and generates the execution plan 210 using autoregressive language modeling within a transformer architecture, allowing the LLM 216 to capture complex patterns and dependencies in the input prompt 227. The LLM's 216 ability to generate the execution plan 210 is a result of its training on diverse and extensive textual data, enabling the LLM to understand human language across a wide range of contexts. During training, the LLM 216 learns to predict the next word in a sequence given the context of the preceding words. This process involves adjusting the model's parameters (weights and biases) based on the errors between its predictions and the actual next words in the training data. When the LLM 216 receives an input such as the input prompt 227, the LLM 216 tokenizes the text into smaller units such as words or sub-words. Each token is then represented as a vector in a high-dimensional space. The LLM 216 processes the input sequence token by token, maintaining an internal representation of context. The LLM's 216 attention mechanism allows it to weigh the importance of different tokens in the context of generating the next word. For each token in the vocabulary, the LLM 216 calculates a probability distribution based on its learned parameters. This probability distribution represents the likelihood of each token being the next word given the context. For example, to generate the execution plan 210, the LLM 216 samples a token from the calculated probability distribution. The sampled token becomes the next word in the generated sequence. This process is repeated iteratively, with each newly generated token influencing the context for generating the subsequent token. The LLM 216 can continue generating tokens until a predefined length or stopping condition is reached.

In some instances, as illustrated in FIG. 2, the LLM 216 may not be able to generate a complete execution plan 210 because it is missing information such as if more information is required to determine an appropriate agent for the response, execute one or more actions, or the like. In this particular instance, the LLM 216 has determine that in order to change the 401k contribution as request by the user, it is necessary to understand whether the user would like to change the contribution by a percentage or certain currency amount. In order to obtain this information, the LLM 216 (or another LLM such as LLM 236) generates end-user response 235 (I'm doing good. Would you like to change your contribution by percentage or amount? [Percentage] [Amount]) to the input prompt 227 that can obtain the missing information such that the LLM 216 is able to generate a complete execution plan 210. In some instances, the response may be rendered within a dialogue box of a UI having one or more UI elements allowing for an easier response by the user. In other instances, the response may be rendered within a dialogue box of a UI allowing for the user to reply using the dialogue box (or alternative means such as a microphone). In this particular instance, the user responds with an additional query 238 (What is my current 401k Contribution? Also, can you tell me the contribution limit?) to gather additional information such that the user can reply to the response 235. The subsequent response—additional query 238—is input into the routing engine 208 and the same processes described above with respect to utterance 202 are executed but this time with the context of the prior utterances/replies (e.g., utterance 202 and response 235) from the user's conversation with the digital assistant. This time, as illustrated in FIG. 2, the LLM 216 is able to generate a complete execution plan 210 because it has all the information it needs.

In some instances, the utterance 202 by the user may be determined by the LLM 216 to be non-sequitur (i.e., an utterance that does not logically follow from the previous utterance in a dialogue or conversation). In such an instance, an execution plan orchestrator can be used to handle the switch among different dialog paths. The execution plan orchestrator is configured to track all the ongoing conversation paths, create a new entry if a new dialog path is created and pause the current ongoing conversation if any, remove the entry if the conversation completes based on the metadata of the new action or user preference, it might generate a prompt message when starting a non-sequitur or resuming the previous one, manage the dialog for the prompt message and either proceed or restore the current conversation, confirm or cancel when the user responds to the prompt for the non-sequitur, and manages a cancel or exit from a dialog.

The execution plan 210 includes an ordered list of agents and/or actions that can be used and/or executed to sufficiently respond to the request such as the additional query 238. For example, and as illustrated in FIG. 2, the execution plan 210 can be an ordered list that includes a first agent 242a capable of executing a first action 244a via an associated asset and a second agent 242b capable of executing a second action 244b via an associated asset. The agents, and by extension the actions, may be ordered to cause the first action 244a to be executed by the first agent 242a prior to causing the second action 244b to be executed by the second agent 242b. In some instances, the execution plan 210 may be ordered based on dependencies indicated by the agents and/or actions included in the execution plan 210. For example, if executing the second agent 242b is dependent on, or otherwise requires, an output generated by the first agent 242a executing the first action 244a, then the execution plan 210 may order the first agent 242a and the second agent 242b to comply with the dependency. As should be understood, other examples of dependencies are possible.

The execution plan 210 is then transmitted to an execution engine 250 for implementation. The execution engine 250 includes a number of engines, including a natural language-to-programming language translator 252, a knowledge engine 254, an API engine 256, a prompt engine 258, and the like, for executing the actions of agents and implementing the execution plan 210. For example, the natural language-to-programming language translator 252, such as a Conversation to Oracle Meaning Representation Language (C2OMRL) model, may be used by an agent to translate natural language into a intermedial logical for (e.g., OMRL), convert the intermediate logical form into a system programming language (e.g., SQL) and execute the system programming language (e.g., execute an SQL query) on an asset 219 such as data stores 223 to execute actions and/or obtain data or information. The knowledge engine 254 may be used by an agent to obtain data or information from the context and memory store 214 or an asset 219 such as files/documents 222. The API engine 256 may be used by an agent to call an API 220 and interface with an application such as retirement fund account management application to execute actions and/or obtain data or information. The prompt engine 258 may be used by an agent to construct a prompt for input into an LLM such as an LLM in the context and memory store 214 or an asset 219 to execute actions and/or obtain data or information.

The execution engine 250 implements the execution plan 210 by running each agent and executing each action in order based on the ordered list of agents and/or actions using the appropriate engine(s). To facilitate this implementation, the execution engine 250 is communicatively connected (e.g., via a public and/or provue network) with the agents (e.g., 242a, 242b, etc.), the context and memory store 214, and the assets 219. For example, as illustrated in FIG. 2, when the execution engine 250 implements the execution plan 210, it will first execute the agent 242a and action 244a using API engine 256 to call the API 220 and interface with a retirement fund account management application to retrieve the user's current 401k contribution. Subsequently, the execution engine 250 can execute the agent 242b and action 244b using knowledge engine 254 to retrieve knowledge on 401k contribution limits. In some instances, the knowledge is retrieved by knowledge engine 254 from the assets 219 (e.g., files/documents 222). In other instances (as in this particular instance), the knowledge is retrieved by knowledge engine 254 from the context and memory store 214. Knowledge retrieval and action execution using the context and memory store 214 may be implemented using various techniques including internal task mapping and/or machine learning models such as additional LLM models. For example, the query and associated agent for “What is 401k contribution limit” may be mapped to a ‘semantic search’ knowledge task type for searching the indices 213 within the context and memory store 214 for a response to a given query. By way of another example, a request such as “Can you summarize the key points relating to 401k contribution” can be or include a ‘summary’ knowledge task type that may be mapped to a different index within the context and memory store 214 having an LLM trained to create a natural language response (e.g., summary of key points relating to 401k contribution) to a given query. Over time, a library of generic end-user task or action types (e.g., semantic search, summarization, compare/contrast, heterogeneous data synthesis, etc.) may be built to ensure that the indices and models within the context and memory store 214 are optimized to the various task or action types.

The result of implementing the execution plan 210 is output data 269 (e.g., results of actions, data, information, etc.), which is transmitted to an output pipeline 270 for generating end-user responses 272. For example, the output data 269 from the assets 219 (knowledge, API, dialog history, etc.) and relevant information from the context and memory store 214 can be transmitted to the output pipeline 270. The output data 269 is appended to the utterance 202 to construct an output prompt 274 for input to the LLM 236. In some instances, context 229 concerning the utterance 202 are additionally appended to the output data 269 and the utterance 202. The context 229 is retrievable from the context and memory store 214 and includes user session information, dialog state, conversation or contextual history, user information, or any combination thereof. The LLM 236 generates responses 272 based on the output prompt 274. In some instances, the LLM 236 is the same or similar model as LLM 216. In other instances, the LLM 236 is different from LLM 216 (e.g., trained on a different set of data, a different architecture, trained for a one or more different tasks, etc.). In either instance, the LLM 236 has a deep generative model architecture (e.g., a reversible or autoregressive architecture with) for generating the responses 272 using similar training and generative processes described above with respect to LLM 216. In some instances, the LLM 236 has over 100 billion parameters and generates the responses 272 using autoregressive language modeling within a transformer architecture, allowing the LLM 236 to capture complex patterns and dependencies in the output prompt 274.

In some instances, the end-user responses 272 may be in the format of a Conversation Message Model (CMM) and output as rich multi-modal responses. The CMM defines the various message types that the digital assistant can send to the user (outbound), and the user can send to the digital assistant (inbound). In certain instances, the CMM identifies the following message types:
text: Basic text message
card: A card representation that contains a title and, optionally, a description, image, and link
attachment: A message with a media URL (file, image, video, or audio)
location: A message with geo-location coordinates
postback: A message with a postback payload
   Messages that are defined in CMM are channel-agnostic and can be created using CMM syntax. The channel-specific connectors transform the CMM message into the format required by the specific channel, allowing a user to run the digital assistant on multiple channels without the need to create separate message formats for each channel.

Lastly, the output pipeline 270 transmits the responses 272 to the end user such as via a user device or interface. In some instances, the responses 272 are rendered within a dialogue box of a GUI allowing for the user to view and reply using the dialogue box (or alternative means such as a microphone). In other instances, the responses 272 are rendered within a dialogue box of a GUI having one or more GUI elements allowing for an easier response by the user. In this particular instance, a first response 272 (What is my current 401k Contribution? Also, can you tell me the contribution limit?) to the additional query 238 is rendered within the dialogue box of a GUI. Additionally, in order to follow-up on obtaining information still required for the initial utterance 202, the LLM 236 generates another response 272 prompting the user for the missing information (Would you like to change your contribution by percentage or amount? [Percentage] [Amount]).

While the embodiment of computing environment 200 in FIG. 2 illustrates the digital assistant interacting in a particular conversation flow, this is not intended to be limiting and is merely provided to facilitate a better understanding of the role and responsibility of the components, services, models, and the like of the computing environment 200 within the conversation flow.

Agenda Guided Conversational Artificial Intelligence Systems with Factual Evaluation

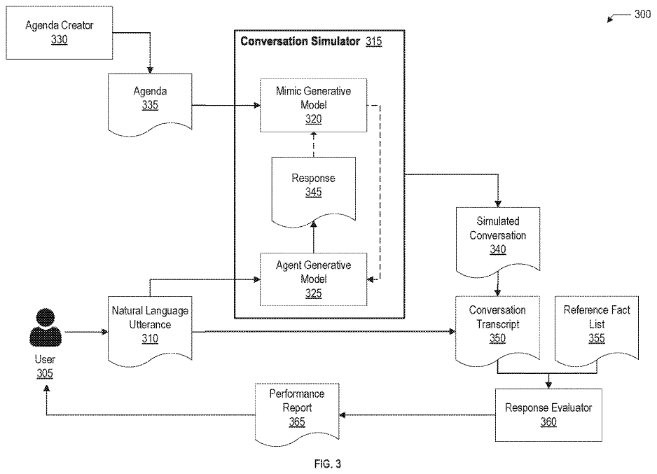

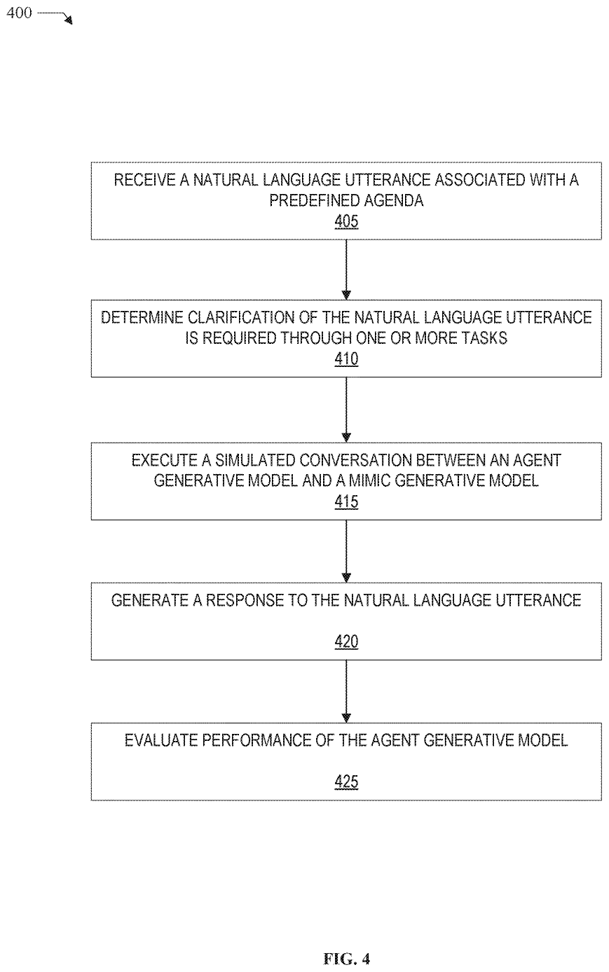

As discussed above with respect to FIGS. 1-2, agents are automated systems designed to help humans accomplish complex tasks using various tools/functions based on generative models such as LLMs. As the landscape of available generative models continues to expand with generative models offering varying capabilities and pricing tiers, it is important to evaluate and use high-performing agents. As described herein, it has been found that performance variations do exist and can be efficiently predicted, and consequently the following description with respect to FIGS. 3-4 introduces an approach for automated evaluation of conversational agents, in which generative models simulate interactions based on structured agendas that define scenario-specific goals, parameters, and constraints. The described approach utilizes agenda-driven simulated conversations between generative models to create contextually appropriate evaluation scenarios for conversational agents. The approach incorporates mechanisms for generating agendas, conducting multi-turn interactions, capturing agent responses and actions, and comparing these to reference data and expected workflows. Evaluation results are compiled in machine-readable formats to support detailed assessment of conversational agent performance across varied operational contexts.

FIG. 3 depicts a simplified block diagram illustrating a system 300 for evaluation of conversational artificial intelligence systems. More specifically, system 300 is configured for evaluating conversational agents, where generative models simulate multi-turn interactions based on structured agendas to assess agent performance. System 300 decomposes agent responses into atomic facts, compares them against predefined reference fact lists, tracks tool/API calls, and outputs machine-readable performance reports, enabling granular, scalable, and objective evaluation of conversational agents' ability to handle complex, realistic scenarios, including disambiguation and slot-filling tasks, and systematically penalizing hallucinated or irrelevant facts. System 300 may be implemented in hardware, software, firmware, or any combination thereof as a stand-alone application, a cloud service, or as part of a larger information extraction pipeline. In some embodiments, system 300 comprises a set of software modules executing on one or more processors in a server, personal computer, or distributed computing environment. In certain embodiments, system 300 comprises a set of software modules executing within a cloud-based infrastructure (e.g., Infrastructure as a Service (IaaS), as further described in connection with FIGS. 5-9), which leverages scalable computing and storage resources to process high volumes of data, thereby ensuring high availability and rapid response times for user interactions. System 300 may be embodied in or accessed via various physical devices, including computers, mobile devices, appliances, networked embedded systems, or vehicles.

As shown in FIG. 3, a user 305 initiates an evaluation by supplying a natural language utterance 310 based on an evaluation scenario. The natural language utterance 310 can take various forms, e.g., may be a text-based, spoken, or otherwise machine-readable query such as “Book a restaurant in Atlanta for four at 7 pm,” it may be a manually crafted test question, a dynamically generated query (for example, using templates or language models), or a scenario-specific prompt designed to test particular agent capabilities. The natural language utterance 310 serves as the starting point for the evaluation process, triggering a simulated conversation. The natural language utterance 310 may be generated either manually by a human or automatically by a system process, supporting both interactive and fully automated testing workflows. In automated instances, the user 305 may represent a test script or evaluation harness, rather than a human, to enable scalable, repeatable testing without human or manual intervention.

The natural language utterance 310 is provided to the conversation simulator 315, which orchestrates a realistic, multi-turn simulated interaction between generative models: the mimic generative model 320 and the agent generative model 325. The mimic generative model 320 is responsible for emulating a user or customer, responding naturally to clarifying questions, confirmations, or other prompts posed by the agent generative model 325. The agent generative model 325 is the conversational agent under evaluation, tasked with interpreting the utterance, requesting clarifications, and generating responses in a manner that reflects its deployed behavior.

During operation, the agent generative model 325 may produce several types of responses at different stages of the simulated conversation 340. For example, upon receiving a natural language utterance 310 such as “Book a restaurant for dinner,” the agent generative model 325 may determine that additional information is needed and generate a clarifying question in the form of, “What city would you like to book the restaurant in?” After the mimic generative model 320 responds with the missing details (e.g., “Atlanta, for four people, at 7 pm”), the agent generative model 325 may then issue a further clarifying question to obtain the type of restaurant preferred, such as, “What type of food or restaurant would you like?” If the mimic generative model 320 responds, “Bistro,” the agent generative model 325 then proceeds to invoke a tool or API, such as a “search_restaurant” function, providing the parameters collected so far, including city, number of guests, date, time, and restaurant type (“Bistro”). Upon receiving the results from the tool call, the agent generative model 325 may issue a confirmation to verify all relevant parameters and its selection, such as, “Please confirm: you would like a dinner reservation at a bistro in Atlanta for four people at 7 pm. Is that correct?” After the mimic generative model 320 confirms the details, the agent generative model 325 generates a final answer that fulfills the user's original request, for instance, “Your reservation for four at 7 pm in Atlanta is confirmed at Joe's Bistro.”

The agent generative model 325 operates by interpreting the natural language utterance 310 and any additional information provided by the mimic generative model 320, with the goal of gathering all necessary details to fulfill the user's request as defined by the agenda 335. At each conversational turn, the agent generative model 325 assesses whether it has acquired sufficient information to execute the intended task, such as booking a reservation, retrieving an account balance, or answering a query. This determination is typically made by internally tracking the set of required input parameters (often referred to as “slots”) needed to complete the scenario, which may include values such as location, date, time, number of guests, or other context-specific details.

Each time the agent generative model 325 generates an output based on the natural language utterance 310, such as a clarifying question, confirmation, or final response, this output is recorded as a response 345. The response 345 is formatted in a structured, machine-readable manner (e.g., JSON, XML, or YAML), and represents a single turn or utterance from the agent generative model 325 within the simulated conversation. The agent generative model 325 may also invoke a sequence of software tools, APIs, or external services as it attempts to fulfill the user's request, which are also recorded as a response 345. For example, if the agent is tasked with booking a restaurant, it may call a table-reservation API, a payment processor, or a location service.

The mimic generative model 320 operates in accordance with an agenda 335, which is generated by the agenda creator 330 and based on the evaluation scenario. The agenda creator 330 may be implemented as a generative model, a rule-based system, or a hybrid, and is responsible for producing the agenda 335 based on the scenario's test requirements. An example generative model agenda extraction prompt is included below:
‘python
agenda_extraction_prompt=“″”
Generate in one sentence the ‘agenda’ for the given task: Book a restaurant reservation for dinner. Extract the slot filling values from this question-answer pair. Be careful and extract the dates as well:
Question: “Book a restaurant for dinner.”
Answer: “I would like a table for four people in Atlanta at 7 pm on Mar. 10, 2026.”
KEEP the whole sentence and ONLY replace the values inside>. ALWAYS Respond using the following template:
“ ”
ASSUME Current Time is >.
Assume you are acting as a human engaging in a conversation with an AI assistant.
You want to ask to book a restaurant reservation for
>.

Use only the city value for locations, DO NOT include the state or the country.

NEVER use city acronyms, replace for the whole name if necessary, e.g. “CDMX” to “Mexico City”. NEVER use states in the city.

The agenda 335 is a structured set of goals, constraints, contextual parameters, and scenario-specific values that define the objectives and boundaries of the simulated conversation. For instance, the agenda 335 may specify the user's intent (e.g., “Book a table at 7 pm for four people”), required slot values (e.g., date, city, number of guests), and special constraints (e.g., “table near a window, vegetarian menu”). The agenda 335 ensures that the mimic generative model 320 maintains a consistent, realistic conversational trajectory, providing clarifications and confirmations only within the agenda's parameters and avoiding divergence or hallucinated information. An example of an agenda prompt template is included below:
‘text
prompt_template: “Assume you are acting as a human engaging in a conversation with an AI assistant.
Your goal is to provide clarification information to the assistant, following this conversation agenda: {agenda}
The assistant is supposed to internally produce a JSON-like answer containing the results of your initial query, and then return you an answer, that could be as a sentence or a list of results.
Say that it's all you wanted to do as soon as that happens. In your responses, be extremely concise and do not use punctuation.
You MUST NOT provide any information or converse on any topic outside of the agenda.
Closely follow the role specified in the agenda.”
agenda: “ASSUME Current Time is Mar. 3, 2026. Before starting interaction, I will provide the given date to align our context to March 2026.
   Now, acting as a human, I will ask the AI assistant: You want to book a dinner reservation for four people in Atlanta at 7 pm on Mar. 10, 2026. No special dietary requirements or seating preferences. You would like to receive confirmation by SMS. If asked, provide any missing information and confirm all details when prompted.”

As the conversation progresses, guided by the agenda 335, each response 345 is appended to the simulated conversation 340, which aggregates all turns of the simulated interaction. For example, in a restaurant reservation scenario, the agent generative model 325 might first output a clarifying question as response 345 “What date would you like the reservation for?”, then an intermediate confirmation as another response 345 “Please confirm: four people at 7 pm next Friday in Atlanta?”, and finally the booking result “Your reservation is confirmed at Joe's Bistro . . . ”. Each of these is sequentially stored as a response 345 and then incorporated into the simulated conversation 340.

In some scenarios, the agent generative model 325 may determine that the natural language utterance 310 provided by the user 305 contains sufficient information to fulfill the request without the need for any clarifying questions. In such cases, the agent generative model 325 processes the natural language utterance 310 directly and generates a response 345 as the output. This response 345 may represent an immediate final response or action, such as confirming a reservation, providing a requested fact, or executing a transaction, depending on the context established by the agenda 335. The response 345 is then recorded as the sole entry for the simulated conversation 340 and used as an input to generate the conversation transcript 350.

The conversation transcript 350 comprises a complete, machine-readable log of the simulated conversation 340, the natural language utterance 310, each response 345 generated by the agent generative model 325 (such as clarifying questions, intermediate confirmations, and final response), as well as any tool or API calls made by the agent generative model 325 during the evaluation scenario. The conversation transcript 350 may be implemented as a machine-readable log, such as JSON, XML, or another structured format, and may also include a detailed record of the agent's internal tool/API calls, their parameters, and results, enabling comprehensive post-hoc analysis. An example of a conversation transcript is included below:

```
‘json
{
  ″scenario_id″: ″restaurant_reservation_001″,
  ″natural_language_utterance″: {
    ″speaker″: ″user″,
    ″turn″: 0,
    ″text″: ″Book a restaurant for dinner.″
  },
  ″turns″: [
    {
      ″turn″: 1,
      ″speaker″: ″agent″,
      ″type″: ″clarifying_question″,
      ″text″: ″What city would you like to book the restaurant in?″,
      ″timestamp″: ″2026-03-03T18:00:01Z″
    },
    {
      ″turn″: 2,
      ″speaker″: ″mimic″,
      ″type″: ″clarifying_response″,
      ″text″: ″Atlanta.″,
      ″timestamp″: ″2026-03-03T18:00:02Z″
    },
    {
      ″turn″: 3,
      ″speaker″: ″agent″,
      ″type″: ″clarifying_question″,
      ″text″: ″For how many people should I make the reservation?″,
      ″timestamp″: ″2026-03-03T18:00:03Z″
    },
    {
      ″turn″: 4,
      ″speaker″: ″mimic″,
      ″type″: ″clarifying_response″,
      ″text″: ″Four people.″,
      ″timestamp″: ″2026-03-03T18:00:04Z″
    },
    {
      ″turn″: 5,
      ″speaker″: ″agent″,
      ″type″: ″confirmation″,
      ″text″: ″Please confirm: you would like a dinner reservation in
Atlanta for four people at 7pm. Is that correct?″,
      ″timestamp″: ″2026-03-03T18:00:05Z″
    },
    {
      ″turn″: 6,
      ″speaker″: ″mimic″,
      ″type″: ″confirmation_response″,
      ″text″: ″Yes, that's correct.″,
      ″timestamp″: ″2026-03-03T18:00:06Z″
    },
    {
      ″turn″: 7,
      ″speaker″: ″agent″,
      ″type″: ″final_answer″,
      ″text″: ″Your reservation for four at 7pm in Atlanta is
      confirmed at Joe's Bistro.″,
      ″timestamp″: ″2026-03-03T18:00:07Z″,
      ″actions″: [
        {
          ″action_type″: ″API_call″,
          ″tool″: ″ReservationService″,
          ″parameters″: {
            ″city″: ″Atlanta″,
            ″guests″: 4,
            ″date″: ″2026-03-10″,
            ″time″: ″19:00″
          },
          ″result″: {
            ″status″: ″confirmed″,
            ″restaurant″: ″Joe's Bistro″
          }
        }
      ]
    }
  ]
}
‘
```

Each turn of the simulated conversation may include not only clarifying questions and responses but also intermediate actions such as tool calls or status updates. For example, consider the following conversation transcript (in JSON), where the agent generative model performs an intermediate tool call in an early turn:

```
‘json
  {
    ″turn″: 3,
    ″speaker″: ″agent″,
    ″type″: ″intermediate_action″,
    ″text″: ″Searching available bistro restaurants in Atlanta for four
    at 7pm...″,
    ″actions″: [
      {
        ″action_type″: ″API_call″,
        ″tool″: ″search_restaurant″,
        ″parameters″: {
          ″city″: ″Atlanta″,
          ″party_size″: 4,
          ″time″: ″19:00″,
          ″type″: ″Bistro″
        },
        ″result″: {
          ″restaurants_found″: [″Joe's Bistro″, ″Cafe Moderne″]
        }
      }
    ],
    ″timestamp″: ″2026-03-03T18:00:05Z″
  }
  ‘
```

After collecting the necessary parameters from the mimic generative model 320, the agent generative model 325 issues an API call to search for available restaurants before confirming the reservation. This intermediate action is recorded as a response 345 in the conversation transcript 350, demonstrating that each turn may include actions toward fulfilling the scenario.

In parallel, the system maintains a reference fact list 355, which is constructed independently of the agenda 335. The reference fact list 355 contains required and optional atomic facts that represent the correct, ground-truth answers for the evaluation scenario. For example, in a table-booking scenario, the reference fact list 355 might specify “Reservation is for 7 pm,” “Number of guests is four,” and “Location is Atlanta.” Generation of the reference fact list 355 typically involves a process in which the system queries or simulates the outputs of known-good tools, mock databases, or scenario-specific ground truth sources using the parameters and values established for the scenario. For instance, the system may invoke the same reservation APIs, data services, or business logic used in production, supplying them with the scenario's relevant inputs, to obtain the actual or expected results that would be returned for a correct execution. The returned outputs are then decomposed into atomic factual statements, such as reservation details, confirmation numbers, event times, or customer attributes. In some embodiments, the reference fact list 355 may be further curated or supplemented by subject matter experts, automated validation scripts, or cross-referencing with canonical datasets to ensure completeness and accuracy. For evaluation scenarios involving dynamic content, such as weather or financial data, the reference fact list 355 may be generated at runtime to reflect the most current or contextually appropriate values.

The reference fact list 355 is maintained in a structured, machine-readable format to facilitate automated comparison and scoring by downstream components. In various embodiments, the reference fact list 355 may be represented as a JSON document, XML file, YAML configuration, or other structured data format suitable for programmatic access. Each atomic fact within the reference fact list 355 is typically stored as a key-value pair or object, indicating the fact's type, value, and whether it is required or optional for the scenario. For example, a JSON representation may include an array of fact objects, each with fields such as “fact_text,” “category” (required/optional), and “value.” This format enables efficient parsing, comparison, and reporting, and supports extensibility for new fact types or domains. An example reference fact list 355 is provided below:

```
‘json
{
  ″scenario_id″: ″restaurant_reservation_001″,
  ″required_facts″: [
    {
      ″fact_text″: ″Number of guests is four″,
      ″category″: ″required″,
      ″key″: ″number_of_guests″,
      ″value″: 4
    },
    {
      ″fact_text″: ″Reservation time is 7pm″,
      ″category″: ″required″,
      ″key″: ″time″,
      ″value″: ″19:00″
    },
    {
      ″fact_text″: ″Location is Atlanta″,
      ″category″: ″required″,
      ″key″: ″location″,
      ″value″: ″Atlanta″
    },
    {
      ″fact_text″: ″Reservation is confirmed″,
      ″category″: ″required″,
      ″key″: ″reservation_status″,
      ″value″: ″confirmed″
    },
    {
      ″fact_text″: ″Restaurant name is Joe's Bistro″,
      ″category″: ″required″,
      ″key″: ″restaurant_name″,
      ″value″: ″Joe's Bistro″
    }
  ],
  ″optional_facts″: [
    {
      ″fact_text″: ″Contact method is SMS confirmation″,
      ″category″: ″optional″,
      ″key″: ″contact_method″,
      ″value″: ″SMS″
    },
    {
      ″fact_text″: ″No special dietary requirements″,
      ″category″: ″optional″,
      ″key″: ″dietary_preferences″,
      ″value″: ″none″
    }
  ],
  ″extra_facts_policy″: ″Any fact not listed above, if present in
the agent response, will be considered an extra fact and penalized.″
}
‘
```

The conversation transcript 350 and reference fact list 355 are both provided to the response evaluator 360. The response evaluator 360 internally comprises an extraction module that decomposes each response generated by the agent generative model 325, including clarifying questions, intermediate confirmations, and final response, into atomic facts. This extraction may utilize a deterministic parser, a generative model, or both, as appropriate. The response evaluator 360 then compares these atomic facts against the reference fact list 355, scoring them for factual accuracy, completeness, and the absence of extra facts outside the reference set (i.e., hallucinations). The response evaluator 360 also compares the logged sequence of tool or API calls taken by the agent generative model 325 against a predefined expected workflow, identifying any deviations, omissions, or errors in the agent's internal decision-making process. For instance, if the agent attempts to request payment before confirming reservation availability, this misstep is flagged and reflected in the evaluation.

The results of this granular assessment are compiled into a performance report 365, which is output in a machine-readable format such as JSON, XML, YAML, or other suitable data serialization formats. The performance report 365 summarizes the agent's strengths, detected errors, hallucinations, and workflow discrepancies, and may be used for automated retraining, fine-tuning, or deployment decisions. In some embodiments, the performance report 365 feeds directly back to the agent generative model 325 or agenda creator 330 as part of a closed-loop improvement process. Below is an example performance report:

```
‘json
{
  ″scenario_id″: ″restaurant_reservation_001″,
  ″natural_language_utterance″: ″Book a restaurant for dinner.″,
  ″evaluation_summary″: {
    ″overall_status″: ″pass″,
    ″score″: 5,
    ″max_score″: 5,
    ″extra_facts_found″: [ ]
  },
  ″fact_level_scores″: [
    {
      ″fact_text″: ″Number of guests is four″,
      ″category″: ″required″,
      ″expected_value″: 4,
      ″agent_value″: 4,
      ″score″: 1,
      ″status″: ″correct″
    },
    {
      ″fact_text″: ″Reservation time is 7pm″,
      ″category″: ″required″,
      ″expected_value″: ″19:00″,
      ″agent_value″: ″19:00″,
      ″score″: 1,
      ″status″: ″correct″
    },
    {
      ″fact_text″: ″Location is Atlanta″,
      ″category″: ″required″,
      ″expected_value″: ″Atlanta″,
      ″agent_value″: ″Atlanta″,
      ″score″: 1,
      ″status″: ″correct″
    },
    {
      ″fact_text″: ″Reservation is confirmed″,
      ″category″: ″required″,
      ″expected_value″: ″confirmed″,
      ″agent_value″: ″confirmed″,
      ″score″: 1,
      ″status″: ″correct″
    },
    {
      ″fact_text″: ″Restaurant name is Joe's Bistro″,
      ″category″: ″required″,
      ″expected_value″: ″Joe's Bistro″,
      ″agent_value″: ″Joe's Bistro″,
      ″score″: 1,
      ″status″: ″correct″
    },
    {
      ″fact_text″: ″Contact method is SMS confirmation″,
      ″category″: ″optional″,
      ″expected_value″: ″SMS″,
      ″agent_value″: null,
      ″score″: 0,
      ″status″: ″not mentioned″
    },
    {
      ″fact_text″: ″No special dietary requirements″,
      ″category″: ″optional″,
      ″expected_value″: ″none″,
      ″agent_value″: null,
      ″score″: 0,
      ″status″: ″not mentioned″
    }
  ],
  ″extra_facts″: [ ],
  ″action_sequence_evaluation″: {
    ″expected_actions″: [
      {
        ″action_type″: ″API_call″,
        ″tool″: ″ReservationService″,
        ″parameters″: {
          ″city″: ″Atlanta″,
          ″guests″: 4,
          ″date″: ″2026-03-10″,
          ″time″: ″19:00″
        }
      }
    ],
    ″agent_actions″: [
      {
        ″action_type″: ″API_call″,
        ″tool″: ″ReservationService″,
        ″parameters″: {
          ″city″: ″Atlanta″,
          ″guests″: 4,
          ″date″: ″2026-03-10″,
          ″time″: ″19:00″
        }
      }
    ],
    ″action_sequence_status″: ″match″
  },
  ″conversation_turns_evaluated″: 7,
  ″evaluation_timestamp″: ″2026-03-03T18:01:00Z″
}
‘
```

The performance report 365 generated by the response evaluator 360 may be utilized in downstream processes for agent retraining, fine-tuning, or deployment. For example, after each evaluation cycle, the system or a user can parse the performance report 365 to identify specific scenarios or responses where the agent generative model 325 failed to provide required facts, introduced hallucinated facts, or deviated from the expected workflow. These cases can be automatically or manually compiled into a fine-tuning dataset, comprising the original natural language utterances, agenda details, agent responses, and the ground-truth facts from the reference fact list 355. This dataset is suitable for use as additional training data, enabling supervised fine-tuning of the agent generative model 325 to minimize factual inaccuracy or hallucination rates. The system may define acceptance thresholds for deployment, such as a minimum factual accuracy score or a maximum number of extra facts allowed, based on the aggregated metrics in the performance report 365. If the agent generative model 325 meets or exceeds these criteria, it may be flagged for deployment or promotion to a production environment; otherwise, further retraining or manual review may be triggered. These downstream improvement and deployment processes may be implemented outside the core evaluation architecture 300, for example as part of a separate model management or machine learning operations workflow. For example, see discussions of FIGS. 1-2 concerning improvement and deployment of agents in an agentic or digital assistant environment.

It is also important to note that the system 300 architecture supports multi-modal and multi-lingual scenarios, enabling the natural language utterance 310 and corresponding agent responses to be provided in text, speech, or other machine-readable forms, and in a variety of languages or dialects. Furthermore, the architecture is designed to accommodate one-to-one, one-to-many, many-to-one, or many-to-many mappings between agendas and utterances, supporting comprehensive batch testing across a wide range of user intents, phrasings, and operational domains.

FIG. 4 presents a process flow 400 for the evaluation of conversational artificial intelligence systems. The processing depicted in FIG. 4 may be implemented in software (e.g., code, instructions, a program) executed by one or more processing units (e.g., one or more processors, cores) of the respective systems, hardware, or combinations thereof described throughout. The software may be stored on a non-transitory storage medium (e.g., on a memory device). Although the methods presented in FIG. 4 depict the various processing steps occurring in a particular sequence or order, this is not intended to be limiting. In certain alternative embodiments, the steps may be performed in parallel and/or in a different order. In certain embodiments, such as in the embodiments depicted in FIGS. 1-3, the processing depicted in FIG. 4 may be performed by a system for the evaluation of conversational artificial intelligence systems, as described with respect to FIGS. 1-3.

At step 405, a natural language utterance associated with a predefined agenda is received. In some instances the agenda is generated by a generative model or is generated automatically based on a schema describing available software tools and parameters for the agent generative model. The natural language utterance many be received from one or more sources, including but not limited to, a human user interacting with a user interface, an automated test harness executing a predefined script, or from a log of historical user interactions for regression testing. The natural language utterance may be in various formats, such as plain text, a spoken command that is converted to text via a speech-to-text module, or a multi-modal input combining text with images or other data. Upon receipt, the natural language utterance may undergo preprocessing, including language detection, normalization, and initial entity extraction. The associated agenda, which provides the ground truth and goals for the evaluation scenario, may be static or dynamically generated at runtime. In some instances, the agenda specifies not only goals and constraints but also a particular persona for the mimic generative model to adopt (e.g., an impatient user, a novice user) to test agent robustness. The association between the utterance and the agenda can be established through direct mapping using scenario identifiers or determined dynamically based on semantic similarity between the utterance and the agenda's defined intent.

At step 410, clarification of the natural language utterance through one or more tasks for responding to the natural language utterance is determined. The determination may be made by the agent generative model based on an analysis of the utterance against the requirements of the associated tools. For example, clarification may be triggered if required slots for an action are missing, if the agent's confidence score for a particular intent is below a predefined threshold, or if the utterance contains ambiguous or conflicting information. In addition to disambiguation, slot filling, and confirmation, the one or more tasks may further comprise constraint negotiation, where the agent identifies a conflict between the user's request and available options and seeks to find a compromise (e.g., “That time is unavailable, would 8 PM work instead?”), or preference elicitation, where the agent proactively asks for user preferences to narrow down a broad request (e.g., “Do you have a preferred seating area?”). If no clarification is deemed necessary, the process may proceed directly to generating a final response.

At step 415, a simulated conversation between an agent generative model and a mimic generative model is executed. In some instances, the one or more tasks comprise disambiguation, slot filling, confirmation, or any combination thereof. In some instances, executing the simulated conversation comprises providing a prompt comprising the predefined agenda to the mimic generative model, and wherein the predefined agenda includes information about the simulated conversation and a goal that needs to be achieved during the simulated conversation.

In some instances, the agent generative model and the mimic generative model are the same model or different models. When using the same model, the system enforces role separation by maintaining independent conversational contexts, prompt templates, and system instructions for each instance. For example, two separate sessions are launched with the same generative model such as a LLM (e.g., GPT-4 for the agent and mimic), one configured with a prompt and agenda to simulate the user (mimic role), and the other configured with system instructions and access to tool APIs to simulate the agent under evaluation (agent role). Each instance maintains its own state and message history, preventing information leakage between roles. In other embodiments, entirely different generative models may be used for each role (e.g., GPT-4 for the agent, and Llama-3 for the mimic), further ensuring separation of behavior and reducing the risk of unintended coordination or bias.

In some instances, the process further comprises generating a conversational transcript based on the natural language utterance, the simulated conversation, and the response, wherein the performance of the agent generative model is evaluated based on the conversational transcript and retraining, fine-tuning, or deploying the agent generative model based on the evaluating.

At step 420, a response to the natural language utterance is generated. In some instances, each turn further comprises performing one or more intermediate actions for gathering of information for performing the one or more tasks, and wherein the one or more clarifying questions are responses generated by the agent generative model during the simulated conversation, the response is a final response generated by the agent generative model, and a conversational transcript comprising the responses, the final response, or both are used for evaluating the performance. The response is generated by the agent generative model and may be generated based on the natural language utterance, the full context of the simulated conversation, and the results of any internal actions or tool calls performed. The response is not limited to clarifying questions or a final response. In some embodiments, the response may be an intermediate response such as a status update (e.g., “I am searching for available tables now . . . ”), an error message if the request cannot be fulfilled, or a multi-modal response that includes not only text but also interactive UI elements such as buttons, images, or hyperlinks. Furthermore, the agent may generate a proactive response that anticipates user needs by suggesting a logical next step or providing related information (e.g., “Your reservation is confirmed. Would you like directions to the restaurant?”). The generation process may be further influenced by user profile information to provide a personalized response.

At step 425, the performance of the agent generative model is evaluated. In some instances, the evaluating comprises decomposing, by an evaluation generative model, the one or more clarifying questions and/or the response in the conversational transcript into a plurality of atomic facts; comparing the plurality of atomic facts against a predefined fact list that includes a set of required facts and a set of optional facts; assigning a score to the one or more clarifying questions and/or the response based on: (i) an accuracy of required facts in the one or more clarifying questions and/or the response as determined by the comparing, (ii) an accuracy of optional facts in the one or more clarifying questions and/or the response as determined by the comparing, and (iii) an absence of extra facts outside of the reference fact list in the one or more clarifying questions and/or the response as determined by the comparing, wherein the score is indicative of accuracy and completeness of the one or more clarifying questions and/or the response and is a metric for evaluating the performance of the agent generative model; recording a sequence of actions (a sequence can be one or more actions) taken by the agent generative model during the simulated conversation, wherein each action comprises a call to a software tool including one or more parameters and comparing the sequence of actions to a predefined expected sequence of actions; and generating a performance report, based on the score and the sequence of actions, in a machine-readable format.

### Examples of Architectures for Implementing Cloud Infrastructures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively coupled to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

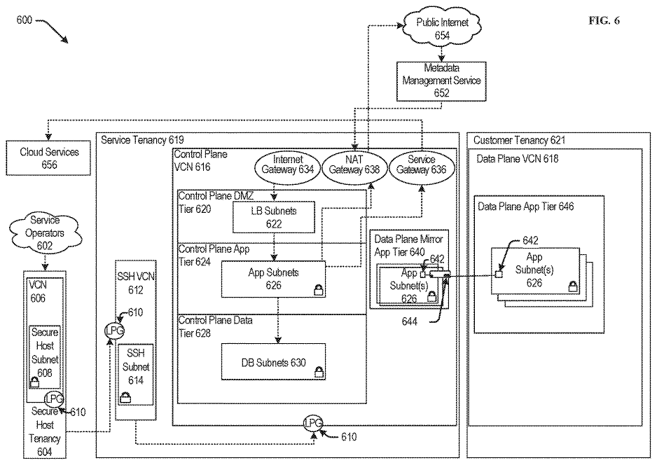

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively coupled to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

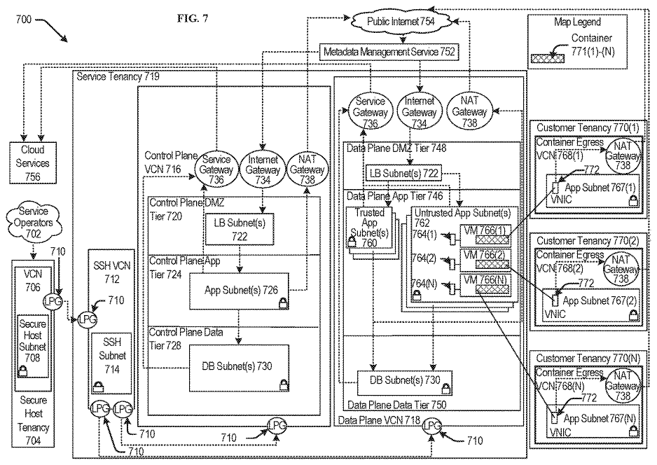

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively coupled to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

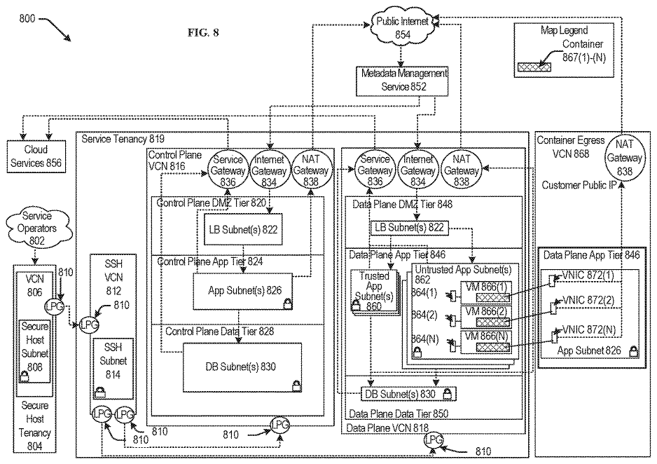

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

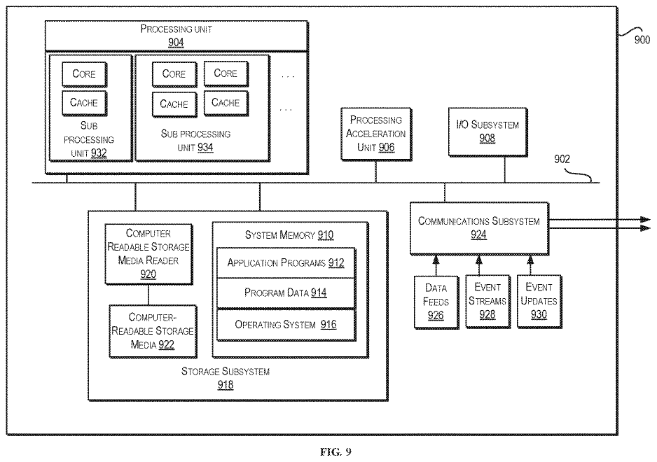

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 904 provide the functionality described above. Storage subsystem 918 may also provide a repository for storing data used in accordance with the present disclosure.

As depicted in the example in FIG. 9, storage subsystem 918 can include various components including a system memory 910, computer-readable storage media 922, and a computer readable storage media reader 920. System memory 910 may store program instructions that are loadable and executable by processing unit 904. System memory 910 may also store data that is used during the execution of the instructions and/or data that is generated during the execution of the program instructions. Various different kinds of programs may be loaded into system memory 910 including but not limited to client applications, Web browsers, mid-tier applications, relational database management systems (RDBMS), virtual machines, containers, etc.

System memory 910 may also store an operating system 916. Examples of operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 900 executes one or more virtual machines, the virtual machines along with their guest operating systems (GOSs) may be loaded into system memory 910 and executed by one or more processors or cores of processing unit 904.

System memory 910 can come in different configurations depending upon the type of computer system 900. For example, system memory 910 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 910 may include a basic input/output system (BIOS) containing basic routines that help to transfer information between elements within computer system 900, such as during start-up.

Computer-readable storage media 922 may represent remote, local, fixed, and/or removable storage devices plus storage media for temporarily and/or more permanently containing, storing, computer-readable information for use by computer system 900 including instructions executable by processing unit 904 of computer system 900.

Computer-readable storage media 922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Machine-readable instructions executable by one or more processors or cores of processing unit 904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
receiving a natural language utterance associated with a predefined agenda;
determining, by an agent generative model, to clarify the natural language utterance through one or more tasks for responding to the natural language utterance;
in response to determining to clarify the natural language utterance, executing a simulated conversation between the agent generative model and a mimic generative model in order to perform the one or more tasks and obtain a clarification of the natural language utterance, wherein the simulated conversation comprises one or more turns and each turn comprises:
generating, by the agent generative model, one or more clarifying questions associated with the one or more tasks; and
generating, by the mimic generative model, one or more clarifying responses to the one or more clarifying questions based on the predefined agenda;
generating, by the agent generative model, a response to the natural language utterance based on the natural language utterance and the simulated conversation; and
evaluating performance of the agent generative model to generate the one or more clarifying questions and/or the response.

2. The computer-implemented method of claim 1, wherein the agenda is generated by a generative model or is generated automatically based on a schema describing available software tools and parameters for the agent generative model.

3. The computer-implemented method of claim 1, wherein each turn further comprises performing one or more intermediate actions for gathering of information for performing the one or more tasks, and wherein the one or more clarifying questions are responses generated by the agent generative model during the simulated conversation, the response is a final response generated by the agent generative model, and a conversational transcript comprising the responses, the final response, or both are used for evaluating the performance.

4. The computer-implemented method of claim 1, further comprising:
generating a conversational transcript based on the natural language utterance, the simulated conversation, and the response, wherein the performance of the agent generative model is evaluated based on the conversational transcript; and
retraining, fine-tuning, or deploying the agent generative model based on the evaluating.

5. The computer-implemented method of claim 1, wherein executing the simulated conversation comprises providing a prompt comprising the predefined agenda to the mimic generative model, and wherein the predefined agenda includes information about the simulated conversation and a goal that needs to be achieved during the simulated conversation.

6. The computer-implemented method of claim 1, wherein the one or more tasks comprise disambiguation, slot filling, confirmation, or any combination thereof.

7. The computer-implemented method of claim 1, further comprising
generating a conversational transcript based on the natural language utterance, the simulated conversation, and the response, wherein the performance of the agent generative model is evaluated based on the conversational transcript, and the evaluating comprises:
decomposing, by an evaluation generative model, the one or more clarifying questions and/or the response in the conversational transcript into a plurality of atomic facts;
comparing the plurality of atomic facts against a predefined fact list that includes a set of required facts and a set of optional facts;
assigning a score to the one or more clarifying questions and/or the response based on: (i) an accuracy of required facts in the one or more clarifying questions and/or the response as determined by the comparing, (ii) an accuracy of optional facts in the one or more clarifying questions and/or the response as determined by the comparing, and (iii) an absence of extra facts outside of the reference fact list in the one or more clarifying questions and/or the response as determined by the comparing, wherein the score is indicative of accuracy and completeness of the one or more clarifying questions and/or the response and is a metric for evaluating the performance of the agent generative model;
recording a sequence of actions taken by the agent generative model during the simulated conversation, wherein each action comprises a call to a software tool including one or more parameters and comparing the sequence of actions to a predefined expected sequence of actions; and
generating a performance report, based on the score and the sequence of actions, in a machine-readable format.

8. The computer-implemented method of claim 1, wherein the agent generative model and the mimic generative model are the same model or different models.

9. A system comprising:
one or more processors; and
one or more computer-readable media storing instructions which, when executed by the one or more processors, cause the system to perform operations comprising:
generating, using a generative model, an agenda based on a test scenario, wherein the agenda comprises a goal for a simulated conversation;
providing, to a mimic generative model, the agenda;
providing, to an agent generative model, a natural language utterance associated with the agenda, wherein the agent generative model is a conversational agent under evaluation;
determining, by the agent generative model, one or more clarifying questions based on the natural language utterance;
performing, by the agent generative model, a sequence of actions for gathering of information for performing one or more tasks associated with the test scenario;
generating, by the mimic generative model, one or more clarifying responses to the one or more clarifying questions, wherein the one or more clarifying responses is based on the agenda;
conducting, by the mimic generative model and agent generative model, the simulated conversation comprising the one or more clarifying questions, the one or more clarifying responses, and a response;
creating, based on the simulated conversation, a conversational transcript;
evaluating, based on the conversational transcript and the sequence of actions taken by the agent generative model during the simulated conversation, the agent generative model; and
generating a performance report, wherein the performance report comprises performance details of the agent generative model in a structured machine-readable format.

10. The system of claim 9, wherein only the mimic generative model has access to the agenda.

11. The system of claim 9, wherein the agenda is generated based on a schema for one or more software tools available to the agent generative model, wherein the schema comprises tool parameters and tool outputs.

12. The system of claim 9, wherein the simulated conversation comprises a plurality of conversational turns, each conversational turn comprising at least one of the one or more clarifying questions from the agent generative model and at least one of the one or more clarifying responses from the mimic generative model.

13. The system of claim 9, wherein the response is an intermediate response or a final response generated by the agent generative model.

14. The system of claim 9, wherein evaluating the agent generative model comprises:
(i) decomposing the one or more responses from the agent generative model in the conversational transcript into a plurality of atomic facts, wherein the one or more responses from the agent generative model comprise all responses generated by the agent generative model during the simulated conversation;
(ii) comparing the plurality of atomic facts against a predefined reference fact list comprising a set of required facts and a set of optional facts;
(iii) assigning a score to the one or more responses based on an accuracy of the required facts, an accuracy of the optional facts, and an absence of extra facts outside of the reference fact list;
(iv) recording the sequence of actions taken by the agent generative model during the simulated conversation, wherein the sequence of actions comprises a sequence of calls to software tools including one or more parameters; and
(v) comparing the sequence of actions to a predefined expected sequence of actions.

15. The system of claim 9, wherein the mimic generative model and the agent generative model are the same models or different models.

16. One or more non-transitory computer-readable media storing instructions which, when executed by one or more processors, causes a system to perform operations comprising:
receiving a natural language utterance associated with a predefined agenda;
determining, by an agent generative model, clarification of the natural language utterance is required through one or more tasks in order to respond to the natural language utterance;
in response to determining clarification is required, executing a simulated conversation between the agent generative model and a mimic generative model in order to perform the one or more tasks and obtain the clarification of the natural language utterance, wherein the simulated conversation comprises one or more turns and each turn comprises:
generating, by the agent generative model, one or more clarifying questions associated with the one or more tasks; and
generating, by the mimic generative model, one or more clarifying responses to the one or more clarifying questions based on the predefined agenda;
generating, by the agent generative model, a response to the natural language utterance based on the natural language utterance and the simulated conversation; and
evaluating performance of the agent generative model to generate the one or more clarifying questions and/or the response.

17. The one or more non-transitory computer-readable media of claim 16, wherein the operations further comprise generating a conversational transcript based on the natural language utterance, the simulated conversation, and the response, wherein:
the performance of the agent generative model is evaluated based on the conversational transcript, and
the evaluating comprises:
decomposing, by an evaluation generative model, the one or more clarifying questions and/or the response in the conversational transcript into a plurality of atomic facts;
comparing the plurality of atomic facts against a predefined fact list that includes a set of required facts and a set of optional facts;
assigning a score to the one or more clarifying questions and/or the response based on: (i) an accuracy of required facts in the one or more clarifying questions and/or the response as determined by the comparing, (ii) an accuracy of optional facts in the one or more clarifying questions and/or the response as determined by the comparing, and (iii) an absence of extra facts outside of the reference fact list in the one or more clarifying questions and/or the response as determined by the comparing, wherein the score is indicative of accuracy and completeness of the one or more clarifying questions and/or the response and is a metric for evaluating the performance of the agent generative model;
recording a sequence of actions taken by the agent generative model during the simulated conversation, wherein each action comprises a call to a software tool including one or more parameters and comparing the sequence of actions to a predefined expected sequence of actions; and
generating a performance report, based on the score and the sequence of actions, in a machine-readable format.

18. The one or more non-transitory computer-readable media of claim 16, wherein the agenda is generated by a generative model or is generated automatically based on a schema describing available software tools and parameters for the agent generative model.

19. The one or more non-transitory computer-readable media of claim 16, wherein the operations further comprise:
generating a conversational transcript based on the natural language utterance, the simulated conversation, and the response, wherein the performance of the agent generative model is evaluated based on the conversational transcript; and
retraining, fine-tuning, or deploying the agent generative model based on the evaluating.

20. The one or more non-transitory computer-readable media of claim 16, wherein the one or more tasks comprise disambiguation, slot filling, confirmation, or any combination thereof.
